(19) United States
(12) Patent Application Publication
(10) Pub. No.: US 2008/0078891 A1
(43) Pub. Date: Apr. 3, 2008

(54) Retention Clip Assembly

(76) Inventor: Blake Hobson, Crystal Lake, IL (US)

Correspondence Address: MCANDREWS HELD & MALLOY, LTD, 500 WEST MADISON STREET, SUITE 3400, CHICAGO, IL, 60661, US

(21) Appl. No.: 11/532,380

(22) Filed: Sep. 15, 2006

(51) Int. Cl. F16L 3/08

(52) U.S. Cl. 248/74.2

(57) ABSTRACT

Retention clip assemblies of the present technology comprise a stanchion portion and a retention clip portion adapted to secure routed lines such as hoses, pipes, electrical lines, tubes and other similar items. Generally, retention clip assemblies of the present technology are affixable to another structure to retain the routed line in close proximity with that structure. In preferred embodiments, retention clip assemblies are particularly adapted to be arc stud welded to a metal substrate.

### FIELD

The present technology relates to retention devices. The present technology is particularly related to retention clip assemblies for use in the retention of routed lines such as hoses, pipes and tubes in applications where the retention device is affixed to another structure and retains the routed line in close proximity to the other structure.

### BACKGROUND

There are many applications that require the retention of routed lines. Examples include applications in which there is a need to retain hoses, pipes, tubes and other similar items, such as: hydraulic supply lines on cylinders; compact construction and agricultural equipment; fixed machinery for routing of electrical, coolant or hydraulic lines; routing of various lines such as hydraulic, water, and electrical on ships; and retention of water or electrical lines in buildings. Retention devices used in these applications often need to be welded to some other structure (for example, a beam or hydraulic cylinder tube). The current constraints of welding dictate that retention devices that are welded in place be manufactured from low to medium carbon steel.

Current retention devices are typically deformed around the item being retained. Some existing approaches to retention devices consist of a tapped mounting boss with a ‘P’ shaped wire clamp (P-clamp), and use a washer and a bolt for retention of the P-clamp to the tapped boss. These approaches can be costly, and are labor intensive and complicated in that they require the use of several parts.

Another approach to retention devices that attempts to solve the problems associated with the use of several parts consists of two pieces that are welded together to form a device that is generally P-shaped. Examples of devices of this nature are commercially available from Samtan Engineering Corporation in Malden, Mass., and from Nelson Stud Welding in Elyria, Ohio. This generally P-shaped retention device is formed from welding a generally C-shaped retainer to a generally cylindrical post. The post has two ends. The weld joint at which the generally C-shaped retainer is attached is the upper end, and the installation weld point, or other attachment means, is located at the lower end.

Although the generally P-shaped retention device described above is an improvement over the tapped mounting boss and P-clamp, there remain several problems associated with this device. For example, because of the odd shape of the device, gripping for proper welding current transfer is difficult. Additionally, current manufacturers allow a wide tolerance on the location of weld joint at which the generally C-shaped retainer is attached relative to the post. This tolerance causes a variation in the offset between individual devices, making the location of the retainer less precise. End user installation is therefore more difficult. Another complication during installation arises with respect to orientation of the device. The welding operator must be careful to ensure proper orientation of the retainer prior to making the installation weld because if the retainer is not correctly oriented, the entire device must be cut off, ground flat and then reinstalled. Similarly, if the generally C-shaped retainer is damaged, the entire device must be cut off in order to install a new one. There are also limitations in the generally P-shaped retention device that are based upon the materials from which the device is constructed. The generally C-shaped retainer must be made from low carbon steel to facilitate the joining of the two pieces of the device by a welding. The low carbon steel, however, results in the retainer fatiguing and having a tendency to open up over time, thus losing its retention ability.

There remains in the industry a need for retention devices that reduce the number parts necessary for installation, are easy to hold during the welding process, reduce or eliminate offset and installation alignment issues, reduce fatiguing of the retainer, and provide for easier replacement damaged retainers.

### BRIEF SUMMARY

The present technology relates to retention devices for the retention of routed lines. Embodiments of retention clip assemblies of the present technology are particularly adapted for use in the retention of hoses, pipes, tubes and other similar items. Embodiments of retention device of the present technology are generally affixed to another structure and used to retain a routed line in close proximity to the other structure.

In one aspect, the present technology relates to a retention clip assembly comprising a retention clip removably attached to a stanchion, where the retention clip includes a retention portion and a mounting portion, the stanchion has an upper portion, a lower portion having an installation end, an outer surface, and a locking portion at which the mounting portion of the retention clip is removably attached.

In another aspect, the present technology relates to a retention clip assembly comprising a retention clip removably attached to a stanchion, where the retention clip includes a retention portion comprising an arc having a first radius and an inner surface adapted to receive a substantially cylindrical item to be retained, and a mounting portion having locking arms to slidably engage and removably attach to the stanchion, and where the stanchion is substantially cylindrical and includes an upper portion, a lower portion having an installation end, and a locking portion at which the mounting portion of the retention clip is slidably received and removably attached.

In a third aspect, the present technology relates to a retention clip for retaining routed lines including a retention portion comprising an arc having a first radius and an inner surface adapted to receive a substantially cylindrical item to be retained, a spacing portion having an arc having a second radius and an inner surface disposed in a transverse direction from the inner surface of the arc of the retention portion, and a mounting portion having locking arms to removably engage a stanchion.

In preferred embodiments, retention assemblies of the present technology are affixed to another structure by arc stud welding. Stanchions for use in such embodiments are made from a weldable material, such as low carbon steel.

Retention clips in preferred embodiments are made from spring steel and are heat-treated to spring temper.

Various embodiments of the present technology provide advantages over current retention devices. For example, certain embodiments of the present technology comprise only two pieces to be installed, aid in lowering the level of complication during installment, provide stanchions that are easy to hold during the welding process, reduce or eliminate offset and installation alignment issues, reduce fatiguing of the retention clips, and provide for easier replacement damaged retention clips.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a perspective view of one embodiment of a retention clip for use with the present technology.

FIG. 2 is a side view of one embodiment of a retention clip for use with the present technology

FIG. 3 is a perspective view of one embodiment of a stanchion for use with the present technology.

FIG. 4 is a side view of one embodiment of a stanchion for use with the present technology.

FIG. 5 is a perspective view of one embodiment of a retention clip assembly installed on a metal substrate and retaining a routed line.

FIG. 6 is a perspective view of one embodiment of a retention clip assembly installed on a metal substrate and retaining a routed line.

### DETAILED DESCRIPTION

The present technology relates to retention devices for the retention of routed lines. Embodiments of retention clip assemblies of the present technology are particularly adapted for use in the retention of routed lines such as hoses, pipes and tubes in applications where the retention device is affixed to another structure and retains the routed line in close proximity to the other structure.

Retention clip assemblies of the present technology comprise a stanchion portion and a retention clip portion adapted to secure routed lines such as hoses, pipes, electrical lines, tubes and other similar items. Preferred retention clip assemblies of the present technology comprise a retention clip removably attached to a stanchion, wherein the retention clip comprises a retention portion and a mounting portion; and wherein the stanchion comprises an tipper portion, a lower portion having an installation end, and a locking portion at which the mounting portion of the retention clip is removably attached.

The discussion provided herein with reference to the Figures illustrates various embodiments of retention clip assemblies of the present technology.

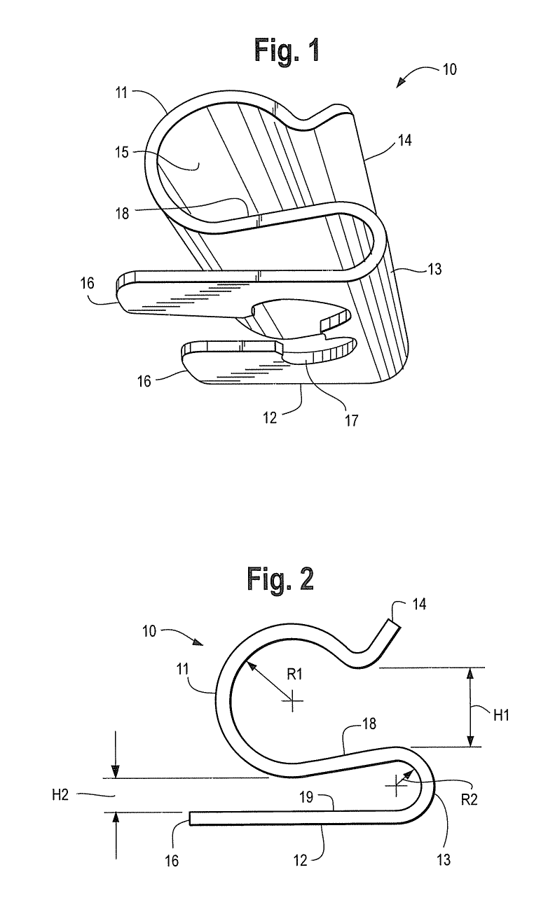

FIGS. 1 and 2 are views of one embodiment of a retention clip for use with the present technology. FIG. 1 is a perspective view of the embodiment and FIG. 2 is a side view of the embodiment.

Referring to FIG. 1, a retention clip 10 comprises the retention portion 11, a spacing portion 13 and a mounting portion 12. As illustrated, the retention portion 11 comprises an arc having a first radius and an inner surface 15 adapted to receive a routed line to be retained. In preferred embodiments, the arc of the retention portion is at least semi-circular, and is preferably greater than semi-circular.

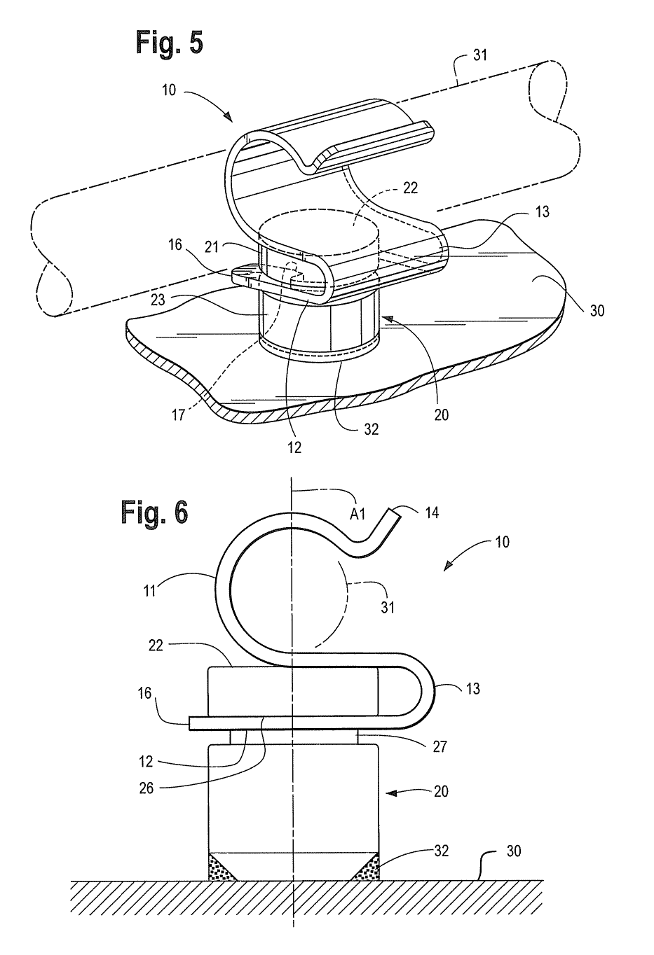

The retention portion 11, as illustrated further, comprises a tab 14. The tab 14 facilitates engagement of the retention portion 11 with a routed line, such as routed line 31 shown in FIG. 5 (e.g. by using the force applied when the routed line 31 is inserted to the retention portion 11 to force the retention portion 11 into an “open” position).

As shown in FIG. 1, the retention clip further comprises a spacing portion 13 comprising an arc having a second radius and an inner surface disposed in a transverse direction from the inner surface of the arc of the retention portion 11.

In preferred embodiments, the mounting portion of the retention clip is configured to be slidably received by the stanchion in forming retention clip assembly. In the embodiment illustrated in FIG. 1, the mounting portion 12 comprises mounting lock 17 having locking arms 16. When the retention clip is attached to the stanchion, locking arms 16 slidably engage the locking portion of the stanchion and deform slightly such that the retention clip snaps into place as the locking portion of the stanchion engages mounting lock 17.

In a particularly preferred embodiment, the retention clip is removably attached to the stanchion. In such embodiments, the retention clip disengages from the stanchion upon the exertion of sufficient force thereon. In the embodiment illustrated in FIG. 1, locking arms 16 of mounting lock 17 would deform as sufficient force is applied to the retention clip so that the retention clip would slidably disengage from the locking portion of the stanchion.

Referring to FIG. 2, the arc having a first radius R1 in the retention portion 11 of the retention clip and the opening of height H1 are shown. The opening of height H1 in the retention portion 11 may be any size suitable for the intended application, but is preferably slightly smaller than the diameter of the routed line in order to facilitate engagement and retention thereof. In a preferred embodiment, the retention portion 11 deforms slightly as a routed line is pressed through the opening of height H1 such that the opening expands to allow the routed line to engage inner surface of the retention portion 11. Once the routed line is engaged, the opening should contract such that the routed line is retained within the retention portion 11 of retaining clip.

As further illustrated in FIG. 2, the spacing portion 13 of the retention clip 10 has an arc of second radius R2, and is configured to result in the mounting portion 12 being spatially separated from the retention portion 11 by a height H2. The height H2 can be any height desired for a particular application, but should be at least slightly smaller than the upper portion of the stanchion so that it applies pressure to the stanchion when the retention clip 10 is slidably engaged and removably attached to the stanchion.

In preferred embodiments, the mounting portion 12 having the inner surface 19 is substantially horizontal when the retention clip is oriented for slidably engaging a stanchion. Additionally, in preferred embodiments, the lower portion 18 of the retention portion 11 is disposed at an angle when the retention clip is oriented for slidably engaging a stanchion. In such embodiments, Height H2 is measured from the substantially horizontal inner surface 19 of the mounting portion 12 to the lowest point of lower portion 18 of the retention portion 11.

The retention clip can be made form any material suitable to the application. In preferred embodiments, the retention clip is made from spring steel, and more preferably the spring steel is heat treated to spring temper. Spring steel resists fatigue as compared to low carbon steel and thus reduces the likelihood of retention clip failure over time.

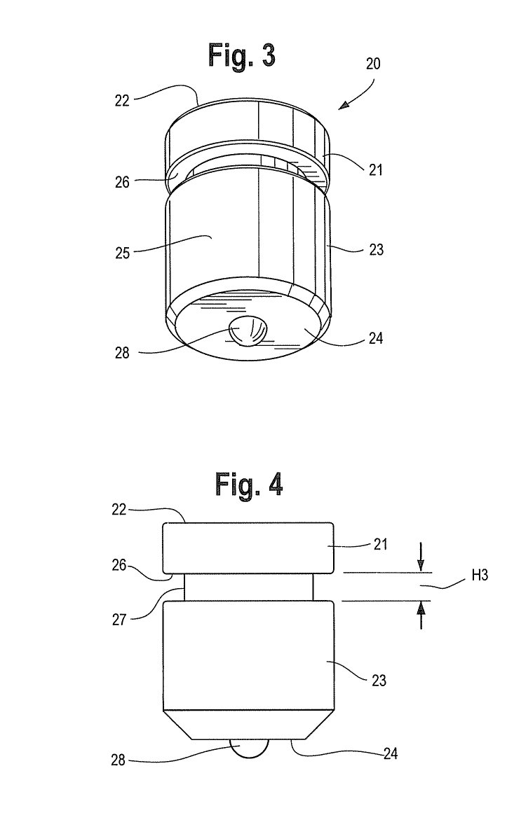

FIGS. 3 and 4 are views of one embodiment of a stanchion for use with the present technology. Referring to FIG. 3, stanchion 20 comprises the upper portion 21 having upper end 22, lower portion 23 having installation end 24, outside surface 25, and locking portion 26. The stanchion 20 is preferably manufactured from low carbon steel, and is more preferably manufactured from low carbon steel of grades C1008 to C1018, and may also be manufactured from other grades of weldable material.

The upper portion 21 of the stanchion 20 as shown in FIG. 3 is substantially cylindrical. In a preferred embodiment, the upper portion 21 has diameter and length dimensions appropriate for the upper portion 21 to be grasped by a stud-welding machine. The diameter of the upper portion 21, and thus upper end 22, can vary over wide limits, but a standard diameter adapted for use with a stud-welding machine is preferred. The stanchion can be different heights to accommodate different retention needs. In some preferred embodiments, the length of stanchion 20 is chosen such that the stanchion 20 is suitable for the intended application. In one embodiment, the length of stanchion 20 is about 0.636 inches. The diameter of the upper portion 21 is chosen such that the upper portion 21 is suitable for engagement with the retention clip 10. In one embodiment, the diameter may be between about 0.375 inches and about 0.5 inches.

In other embodiments, the upper portion 21 of stanchion 20 is not substantially cylindrical, but instead can be any shape suitable for grasping during installation of the stanchion and adapted for use with the clip portion of the retention clip assembly.

Lower portion 23 of stanchion 20, as shown in FIG. 1, may also be substantially cylindrical. In a preferred embodiment, lower portion 23 has the same diameter as the upper portion 21 and the stanchion is substantially cylindrical. Lower portion 23 may alternatively have a diameter that is larger or smaller than the diameter of the upper portion 21.

Referring to FIG. 4, the locking portion 26 as shown is disposed along the length of stanchion 20 such that the upper portion 21 is above locking portion 26 and lower portion 23 is below locking portion 26. In the embodiment of FIGS. 3 and 4, locking portion 26 is a groove forming an indented ring in stanchion 20 such that inner surface 27 of the groove has a diameter smaller than the diameter of outer surface 25 of stanchion 20. In other embodiments, the locking portion of the stanchion comprises notched grooves that result in indentations along portions of stanchion 20, or other configurations suitable to receive the mounting portion of the retention clip.

In preferred embodiments, the retention assembly is affixed to another structure, such as a metal substrate. One such embodiment is illustrated in FIGS. 3 and 4. As shown in FIGS. 3 and 4, the installation end 24 of stanchion 20 includes a flux load 28 that may be used to stud weld the stanchion 20 to the metal substrate 30 (shown in FIG. 5). The stanchion 20 may, however, be affixed to the substrate 30 using any suitable means, including for example a wire weld, an arc weld, a bolt, or other suitable means.

As illustrated, the transition between lower portion 23 and installation end 24 is beveled. In other embodiments, the transition can be rounded, straight, or can be any other configuration suitable for installation in a given embodiment. In one embodiment, for example, the lower portion of the stanchion comprises a threaded outer surface such that the assembly can be installed by screwing the stanchion onto/into the structure. In yet another embodiment, the stanchion can be affixed to another structure by a screw. In such an embodiment, the stanchion may comprise an annular collar disposed around the installation end of the stanchion such that screws can be passed through the collar to affix the stanchion. In other embodiments, the assembly may be affixed to another structure in any way that preferably results in secure affixation of the assembly to the structure.

In preferred embodiments, the retention clip can be mounted onto the stanchion in any orientation. In such an embodiment, the stanchion is preferably straight and is installed perpendicular to the structure to which it is affixed, or at least perpendicular to a horizontal or vertical tangent thereof, depending upon the application. Additionally, in such embodiments, the locking portion of the stanchion is a continuous groove forming an indented ring in the stanchion, as discussed with respect to FIGS. 3 and 4 above, such that the retention clip is rotatable once it has been attached to the stanchion. One preferred embodiment of this type is illustrated in FIGS. 5 and 6.

FIG. 5 is a perspective view of one embodiment of a retention clip assembly of the present technology installed on a metal substrate 30 and retaining a routed line 31. FIG. 6 is a side view of the embodiment of FIG. 5. As illustrated, stanchion 20 is affixed to metal substrate 30 at weld joint 32. The mounting portion 12 of the retention clip 10 is engaged with locking portion 26 of stanchion 20. In this embodiment, prior to routed line 31 being engaged within the retention portion 11 of the retention clip 10, the retention clip 10 can be rotated to any orientation while maintaining its engagement with the locking portion of the stanchion. As shown, routed line 31 is engaging the retention portion 11 such that it is retained in close proximity to structure 30 by the retention assembly.

Referring to FIG. 6, the mounting portion 12 of the retention clip 10 is shown as having a thickness smaller than the height of locking portion 26 of stanchion 20. In preferred embodiments, the thickness of the mounting portion is equal to or is only slightly less than the height of the locking portion of the stanchion.

As shown in FIG. 6, the installation end of the stanchion is affixed to the metal substrate 30 at a desired location. Preferably, the center point of the retention portion is aligned with the center point of the stanchion when the retention clip is attached to the stanchion. In such an embodiment, the retention portion 11 of retention clip 10 is centered along an axis Al that extends through the center of the stanchion 20 (for example the center of the flux load 28, illustrated in FIGS. 3 and 4) perpendicularly from the surface of the installation end and/or the metal substrate 30. In at least one preferred embodiment, the radius R1 of retention portion 11, as shown in FIG. 2, is measured from the center point of retention portion 11, and it is this center point that lies along axis Al when the retention clip is engaged with the stanchion 20. In this manner, this preferred embodiment achieves an advantage over current systems, in that the installer of the stanchion 20 can simply choose the desired location of the stanchion 20 and the routed line 31 will be centered over that desired location. Moreover, because the retention clip 11 and the stanchion 20 are preferably two separate pieces that are rotatably connected, the retention clip 10 can be rotated or adjusted on the stanchion 20 without changing the location of the center of the retention clip (and therefore without changing the location at which the routed line 31 will be retained).

A preferred method of installation relating to retention clip assemblies of the present technology comprises welding the stanchion to a metal substrate, and slidably engaging the retention clip and the locking portion of the stanchion such that the retention clip is removably attached to the stanchion. A routed line can then be inserted into the retention portion of the retention clip such that it is engaged by the retention portion.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A retention clip assembly comprising:
a retention clip removably attached to a stanchion;
wherein the retention clip comprises a retention portion and a mounting portion; and
wherein the stanchion comprises an upper portion, a lower portion having an installation end, an outer surface, and a locking portion at which the mounting portion of the retention clip is removably attached.

2. The retention clip assembly of claim 1, wherein the retention portion of the retention clip comprises an arc having a first radius, a center point from which the first radius is measured, and an inner surface adapted to receive a substantially cylindrical item to be retained.

3. The retention clip assembly of claim 2, wherein the center point of the retention portion is aligned with a center point of the stanchion when the retention clip is attached to the stanchion.

4. The retention clip assembly of claim 2, wherein the retention clip further comprises a spacing portion comprising an arc having a second radius and an inner surface disposed in a transverse direction from the inner surface of the arc of the retention portion.

5. The retention clip assembly of claim 1, wherein the mounting portion slidably engages the stanchion and comprises a mounting lock having locking arms to removably engage the stanchion.

6. The retention clip assembly of claim 1, wherein the retention clip comprises spring steel.

7. The retention clip assembly of claim 6, wherein at least a portion of the retention clip is heat-treated to spring temper.

8. The retention clip assembly of claim 1, wherein the retention clip is rotatably attached to the stanchion.

9. The retention clip assembly of claim 1, wherein the stanchion is substantially cylindrical, wherein the lower portion of the stanchion has substantially the same diameter as the upper portion of the stanchion.

10. The retention clip assembly of claim 9, wherein the locking portion of the stanchion comprises a continuous groove in a circumference of the stanchion, and wherein the groove comprises an inner surface having a diameter smaller than the diameter of the outer surface of the stanchion.

11. The retention clip assembly of claim 1, wherein the locking portion of the stanchion comprises notched grooves.

12. The retention clip assembly of claim 1, wherein the stanchion comprises low carbon steel.

13. The retention clip assembly of claim 12, wherein the stanchion comprises steel of a grade from C1008 to C1018.

14. The retention clip assembly of claim 1, wherein the diameter of the upper portion of the stanchion is between about 0.375 inches to about 0.5 inches.

15. The retention clip assembly of claim 1, wherein the installation end of the stanchion comprises a flux load.

16. The retention clip assembly of claim 1, wherein the lower portion of the stanchion comprises a threaded outer surface.

17. A retention clip assembly comprising a retention clip removably attached to a stanchion,
wherein the retention clip comprises a retention portion comprising an arc having a first radius and an inner surface adapted to receive a substantially cylindrical item to be retained, and a mounting portion having locking arms to slidably engage and removably attach to the stanchion; and
wherein the stanchion is substantially cylindrical and comprises an upper portion, a lower portion having an installation end, and a locking portion at which the mounting portion of the retention clip is slidably received and removably attached.

18. The retention clip assembly of claim 17, wherein the retention clip further comprises a spacing portion comprising an arc having a second radius and an inner surface disposed in a transverse direction from the inner surface of the arc of the retention portion.

19. The retention clip assembly of claim 17, wherein the locking portion of the stanchion comprises a continuous groove in a circumference of the stanchion, and wherein the groove comprises an inner surface having a diameter smaller than the diameter of the outer surface of the stanchion.

20. The retention clip assembly of claim 17, wherein the locking portion of the stanchion comprises notched grooves.

21. The retention clip assembly of claim 17, wherein the retention clip comprises spring steel and the stanchion comprises low carbon steel.

22. A retention clip for retaining routed lines comprising:
a retention portion comprising an arc having a first radius and an inner surface adapted to receive a substantially cylindrical item to be retained;
a spacing portion comprising an arc having a second radius and an inner surface disposed in a transverse direction from the inner surface of the arc of the retention portion;
and a mounting portion comprising a mounting lock having locking arms to removably engage a stanchion.
